(19) United States
(12) Patent Application Publication
(10) Pub. No.: US 2004/0230606 A1
(43) Pub. Date: Nov. 18, 2004

(54) Mechanism for enabling persistence of abstract and versioned dependent value objects

(75) Inventors: James E. Carey, Rochester, MN (US); Marybeth G. Markland, Rochester, MN (US); Mark A. Pasch, Rochester, MN (US)

Correspondence Address: Robert R. Williams, IBM Corporation, Dept. 917, 3605 Highway 52 North, Rochester, MN, 55901-7829, US

(73) Assignee: INTERNATIONAL BUSINESS MACHINES CORPORATION, ARMONK, NY

(21) Appl. No.: 10/438,397

(22) Filed: May 15, 2003

(51) Int. Cl. G06F 7/00

(52) U.S. Cl. 707/103 R

(57) ABSTRACT

A method, apparatus and article of manufacture for processing entity beans in relational database environments. One embodiment provides a method for persisting data from an entity bean in a relational database. The entity bean has a plurality of attributes. At least a portion of the plurality of attributes is associated with one or more dependent value objects. The method comprises determining a dependent value object level of the entity bean defining mapped data attributes from a dependent value object of the plurality of attributes, mapping the mapped data attributes from the dependent value object into a plurality of columns of a row in a table of the relational database, and streaming all remaining attributes from the dependent value object to a separate column of the table.

### BACKGROUND OF THE INVENTION

1. Field of the Invention

The present invention generally relates to data processing in data processing systems and more particularly to processing entity beans in database environments.

2. Description of the Related Art

Databases are computerized information storage and retrieval systems. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, in a database management system, a requesting entity (e.g., an application or the operating system) demands access to a specified database by issuing a database access request. Such requests may include, for instance, simple catalog lookup requests or transactions and combinations of transactions that operate to read, change and add specified records in the database. These requests are made using high-level query languages for getting information from and updating a database such as International Business Machines' (IBM) DB2, Microsoft's SQL Server, and database products from Oracle, Sybase, and Computer Associates. The term “query” denominates a set of commands for retrieving data from a stored database. Queries take the form of a command language that lets programmers and programs select, insert, update, find out the location of data in a database, and so forth.

One of the issues faced by data mining and database query applications, in general, is their close relationship with a given database schema (e.g., a relational database schema). This relationship makes it difficult to support an application as changes are made to the corresponding underlying database schema. Further, the migration of the application to alternative underlying data representations is inhibited. Also the migration of an existing underlying database schema to an alternative application for use with this existing underlying database schema is inhibited.

A typical approach used to address the foregoing problems is software encapsulation. Software encapsulation involves using a software interface or component to encapsulate access methods to a particular underlying data representation. An example is found in the Enterprise JavaBean (EJB) specification that is a component of the Java 2 Enterprise Edition (J2EE) suite of technologies. In a computer network using the client/server model, EJB is an architecture for setting up program components written in the Java programming language that run on the server side of the computer network. The application that runs the EJB is sometimes called an application server.

In the case of EJB, entity beans serve to encapsulate a given set of data, exposing a set of Application Program Interfaces (APIS) that can be used to access information contained in the underlying database. This is a highly specialized approach requiring the software to be written (in the form of new entity beans) whenever a new set of data is to be accessed or when a new pattern of data access is desired. Entity beans may provide “fine-grained” object access or “coarse-grained” object access to the database. Fine-grained object access refers to accessing relatively small objects, such as, for instance, when an object model has been designed to use separate entity beans for an employee, his manager, and his address. In contrast thereto, coarse-grained object access refers to accessing relatively large objects, such as might occur if, for instance, all information for the employee, his manager, and his address were contained within a single entity bean.

Data and logic in an EJB, which need to be manipulated by an application, are maintained in what may be referred to as “business objects”. Building coarse-grained entity beans may involve use of dependent objects or dependent value objects to model the business objects. In the following, the dependent objects are interchangeably referred to as dependent value objects (DVOs). DVOs are stored inside the corresponding entity beans and are created, modified and removed by the entity beans. Such DVOs are plain Java classes, which are transportable over a network and persistent in storage, i.e., the DVOs continue to exist in storage after the application that created them ceases executing.

However, implementing the DVOs in an EJB environment is a complex task and it is difficult to achieve persistence of abstract and versioned DVOs. An abstract DVO represents a parent node defining generic attributes for related DVOs representing child nodes. A versioned DVO can be such a child node associated with a specific parent node. A versioned DVO may also be a DVO that is modified, e.g., when performing modifications to the underlying database table. In this case, the modified DVO represents a new version of a previous DVO. For instance, an abstract DVO for a diesel engine of a car may define generic attributes for describing the diesel engine in general. Versioned DVOs based on this abstract diesel engine DVO may, for instance, describe diesel engines of the same type having different motor capacities or a diesel engine of a specific type which has been modified, e.g., by adding further components.

In a relational database environment, a DVO can be streamed into a single column in a database table representing the corresponding entity bean, if the single column in the database table is configured to accept data in binary format. Streaming data into binary format is a familiar concept to those skilled in the art in other contexts, such as communicating data with a network port. However, a problem consists in that although a DVO can be streamed into a single column, in order to effectively use the DVO, its attributes have to be explicitly schema mapped to individual columns in the database table (for example, using the composer of International Business Machines' WebSphere Application Server). However, if the attributes of the DVO change, for instance when additional data is used with a new version of the DVO after the schema mapping has been done, the mapping must be replaced and the database schema changed by schema mapping the DVO relating to the additional data to corresponding individual columns in the database table.

Therefore, there is a need for a method and system adapted to provide increased flexibility in using DVOs for accessing data of a database table in a relational database environment.

### SUMMARY OF THE INVENTION

The present invention is generally directed to a method and article of manufacture for data processing in data processing systems and more particularly for processing entity beans in relational database environments.

One embodiment provides a method for persisting data from an entity bean in a relational database, the entity bean having a plurality of attributes, at least a portion of the plurality of attributes being associated with one or more dependent value objects. The method comprises determining a dependent value object level of the entity bean defining mapped data attributes from a dependent value object of the plurality of attributes, mapping the mapped data attributes from the dependent value object into a plurality of columns of a row in a table of the relational database, and streaming all remaining attributes from the dependent value object to a separate column of the table.

Another embodiment provides a method for hydrating an entity bean with data from a row in a database table of a relational database, the row having a plurality of columns for mapped data attributes and a column for streamed data attributes associated with a dependent value object. The method comprises determining a dependent value object level of the row defining the mapped data attributes mapped to the plurality of columns for mapped data attributes, hydrating the dependent value object with the mapped data attributes from the plurality of columns for mapped data attributes, extracting the streamed data attributes from the plurality of columns for streamed data attributes, and hydrating the dependent value object with the extracted streamed data attributes.

Still another embodiment provides a computer readable medium containing a program which, when executed, performs an operation for persisting data from an entity bean in a relational database. The entity bean has a plurality of attributes. At least a portion of the plurality of attributes is associated with one or more dependent value objects. The operation comprises determining a dependent value object level of the entity bean defining mapped data attributes from a dependent value object of the plurality of attributes, mapping the mapped data attributes from the dependent value object into a plurality of columns of a row in a table of the relational database and streaming all remaining attributes from the dependent value object to a separate column of the table.

Still another embodiment provides a computer readable medium containing a program which, when executed, performs an operation for hydrating an entity bean with data from a row in a database table of a relational database. The row has a plurality of columns for mapped data attributes and a column for streamed data attributes which are associated with a dependent value object. The operation comprises determining a dependent value object level of the row defining the mapped data attributes mapped to the plurality of columns for mapped data attributes, hydrating the dependent value object with the mapped data attributes from the plurality of columns for mapped data attributes, extracting the streamed data attributes from the column for streamed data attributes and hydrating the dependent value object with the extracted streamed data attributes.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings. P It is to be noted, however, that the appended drawings illustrate only typical embodiments of this invention and are therefore not to be considered limiting of its scope, for the invention may admit to other equally effective embodiments.

FIG. 1 is an illustrative processing system.

FIG. 2 is a relational view illustrating the relationship between different components of the invention.

FIG. 3 is a data structure illustrating an entity bean and a related DVO.

FIG. 4 is a database table illustrating an exemplary entity bean.

FIG. 5 is a data structure illustrating two related DVOs.

FIG. 6 is a database table illustrating the relationship between related DVOs.

FIG. 7 is a database table illustrating an exemplary entity bean.

FIG. 8 is a flowchart illustrating one embodiment of a method performed by an externalize object program according to the invention.

FIG. 9 is a flowchart illustrating one embodiment of a method performed by an internalize object program according to the invention.

### DETAILED DESCRIPTION OF THE PREFERRED EMBODIMENTS

Introduction

The present invention is generally directed to a method and article of manufacture for data processing in data processing systems and more particularly for processing an entity bean in a relational database environment. An entity bean usually contains a plurality of attributes. At least a portion of the plurality of attributes may be associated with one or more DVOs contained in the entity bean. The one or more DVOs thus form an instance part of the entity bean. A DVO may inherit all attributes of another DVO.

According to one aspect of the invention, the attributes associated with a DVO may be explicitly schema mapped to individual columns in a corresponding database table in a relational database or streamed as a binary stream to a suitable column in the corresponding database table. According to another aspect, the attributes associated with the DVO may be extracted from the individual columns or from the binary stream and stored in the entity bean which contains the DVO.

More specifically, one embodiment of the invention is directed to persisting data from an entity bean in a relational database using an externalize object program. Persisting data refers to storing the data in the relational database in a permanent manner such that it needs to be explicitly deleted in order to be removed from the relational database. The externalize object program determines a dependent value object level of the entity bean defining from the plurality of attributes data attributes to be mapped (referred to as “mapped data attributes”) and maps the mapped data attributes from an associated DVO into a plurality of columns of a row in a database table of the relational database. All remaining attributes are streamed from the DVO to a separate column of the table. The externalize object program may, for instance, determine a version number of a DVO contained in the entity bean as the dependent value object level and stream all attributes occurring after this version number into a binary stream. In this case, the externalize object program traverses any superclasses of the DVO to determine the attributes to be streamed. The binary stream is then stored in a column of the database table which is adapted to receive the binary stream.

Another embodiment of the invention is directed to hydrating an entity bean with data from a row in a database table of a relational database using an internalize object program. Hydrating the entity bean refers to storing the data in the entity bean. According to this embodiment, for each DVO the row has a plurality of columns for mapped data attributes and one column for data attributes which are streamed to a binary stream (referred to as “streamed data attributes”). The internalize object program determines a dependent value object level of the row defining the mapped data attributes mapped to the plurality of columns for mapped data attributes and hydrates an associated DVO in the entity bean with the mapped data attributes from the plurality of columns for mapped data attributes. Furthermore, the internalize object program extracts the streamed data attributes from the binary stream stored in the column for streamed data attributes and hydrates the associated DVO with the extracted streamed data attributes. In other words, when the DVO is created from the row in the database table, the mapped data attributes may be stored in the entity bean as they are explicitly schema mapped (thus representing “known” attributes) and, consequently, need not to be further processed. However, the binary stream containing the streamed data attributes needs to be analyzed by the internalize object program to determine and extract the streamed data attributes there from. The internalize object program then sets the extracted streamed data attributes in the entity bean when hydrating the DVO.

Preferred Embodiments

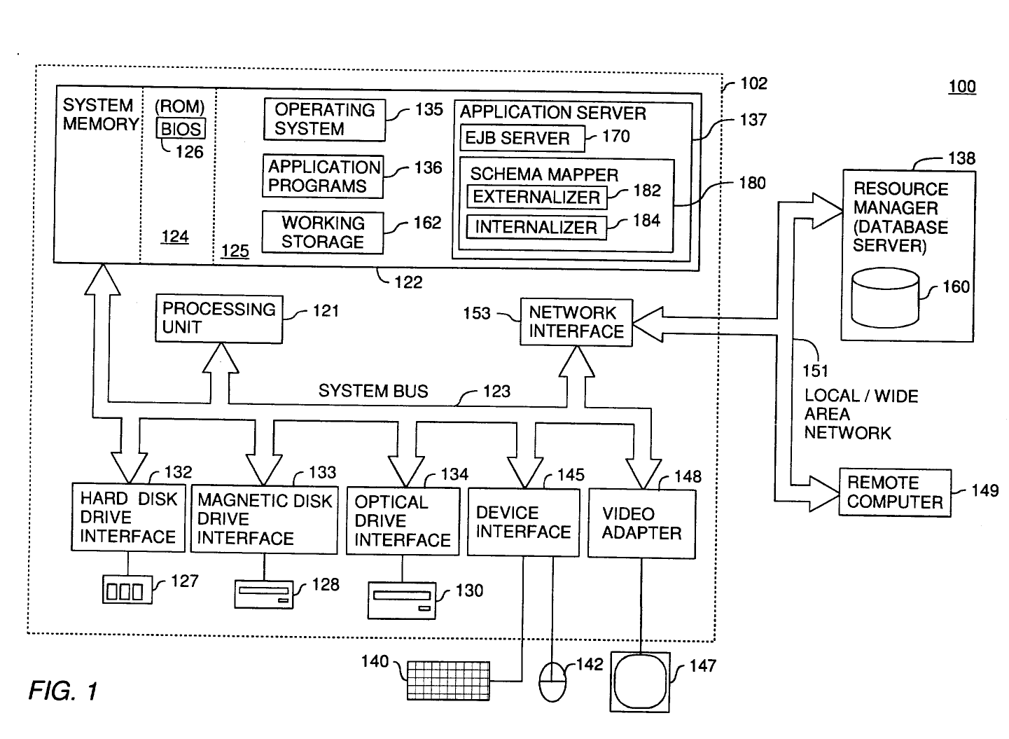

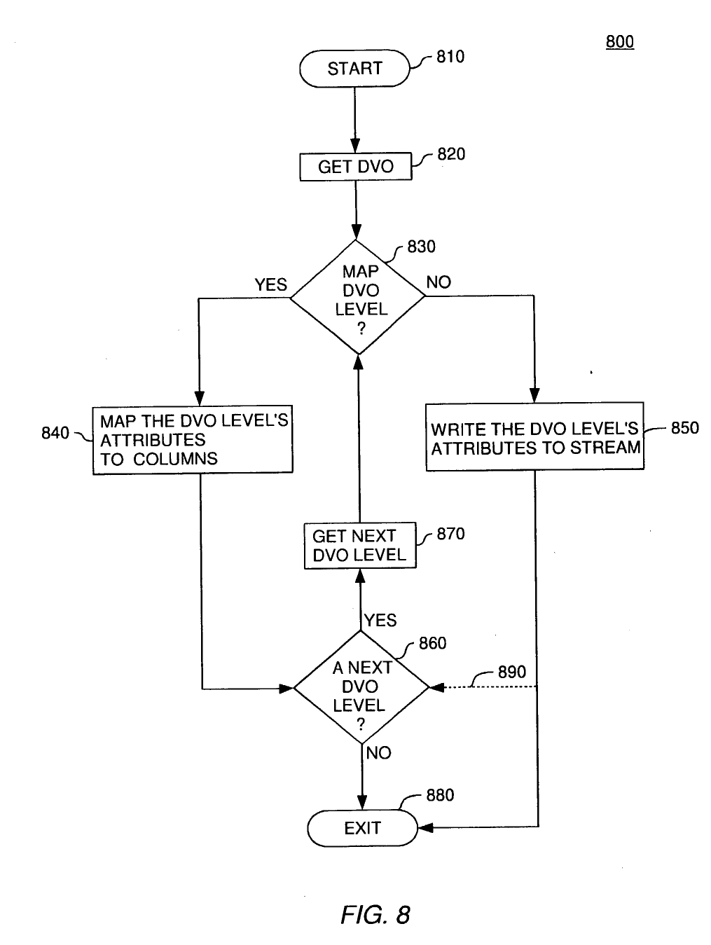

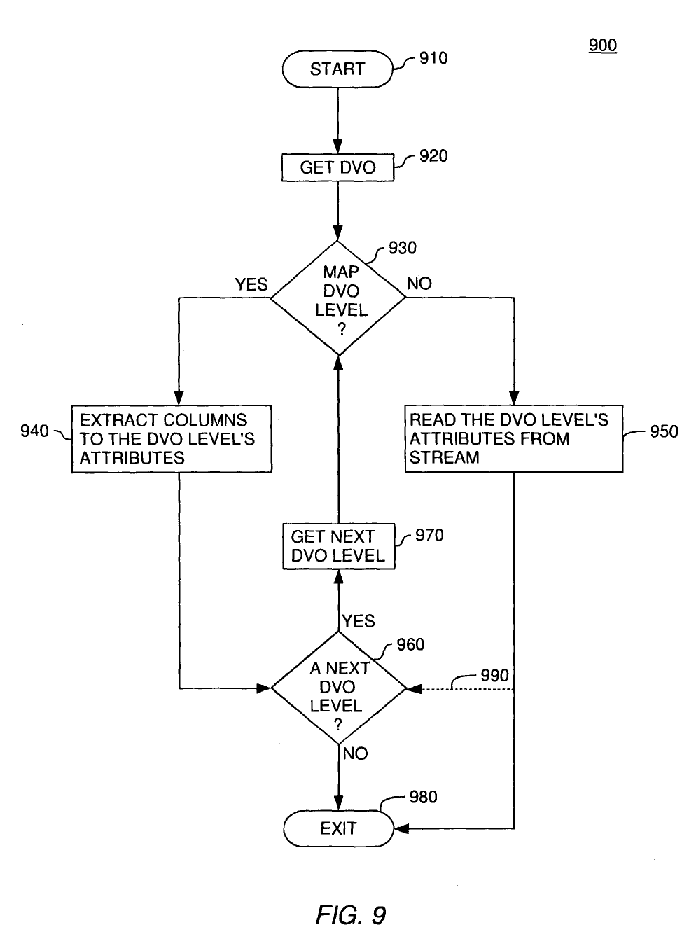

One embodiment of the invention is implemented as a program product for use with a computer system such as, for example, processing environment 100 shown in FIG. 1 and described below. The program(s) of the program product defines functions of the embodiments (including the methods described below with reference to FIGS. 8 and 9) and can be contained on a variety of signal/bearing media. Illustrative signal/bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program”. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Some embodiments of the present invention are described in the context of databases. However, embodiments within the scope of the invention are applicable to any data processing system in which it is desirable to ensure the validity of data that is represented in a persistent form as well as in transient form (e.g., stored in cache or other temporary memory location). Further, while the following embodiments are described with reference to EJBs, the present invention is not so limited.

FIG. 1 is a processing environment 100 generally comprising a computer system 102 communicating with a remote computer 149. Illustratively, the computer system 102 includes a processing unit 121, a system memory 122, and a system bus 123 that operatively couples various system components, including the system memory 122, to the processing unit 121. There may be only one or there may be more than one processing units 121, such that the processor of computer system 102 includes a single central-processing unit (CPU), or a plurality of processing units, as in the case of a multiprocessor system.

The system bus 123 may be any of several types of bus structures including a memory bus or memory controller, a peripheral bus, and a local bus using any of a variety of bus architectures. The system memory 122 may also be referred to as simply the “memory”, and includes read only memory (ROM) 124 and random access memory (RAM) 125. A basic input/output system (BIOS) 126 stored in ROM 124 contains the basic routines that help to transfer information between elements within the computer system 102, such as during start-up. A portion of the system memory 122 is set aside as working storage 162. Illustratively, the working storage 162 is shown as a part of the random access memory 125. However, the working storage 162 may be established in any memory space and in particular in high-speed memory devices, such as cache memory. In other embodiments, working storage includes storage on devices such as hard disks.

The computer system 102 further includes a plurality of storage access devices, which may be configured with working storage. Such devices include a hard disk drive 127, a magnetic disk drive 128, and an optical disk drive 130 (e.g., a CD-ROM or DVD drive). The hard disk drive 127, magnetic disk drive 128, and optical disk drive 130 are connected to the system bus 123 by a hard disk drive interface 132, a magnetic disk drive interface 133, and an optical disk drive interface 134, respectively. The drives and their associated computer-readable media provide nonvolatile storage of computer-readable instructions, data structures, program modules and other data for the computer system 102. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the exemplary operating environment.

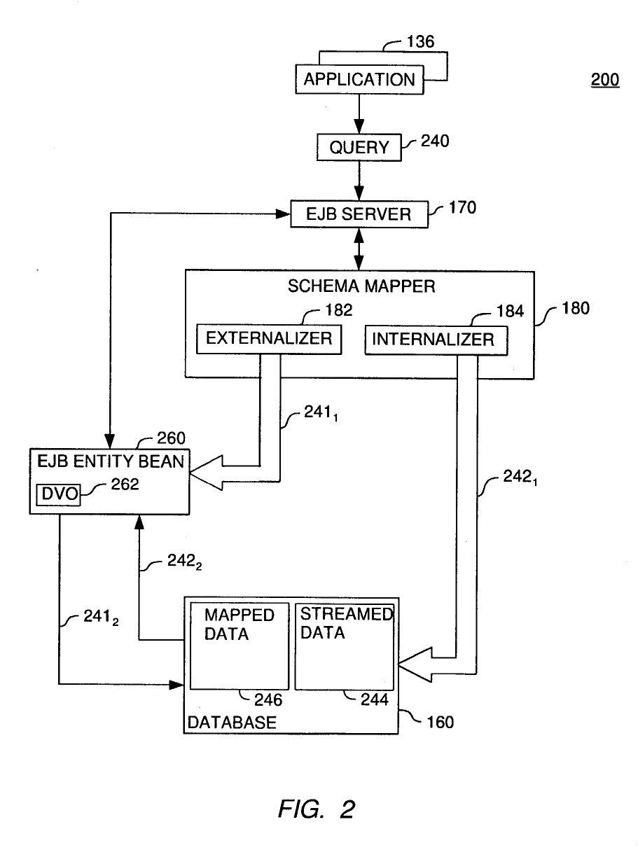

A number of program modules and data structures may be stored on the media readable hard disk drive 127, magnetic disk drive 128, optical disk drive 130, ROM 124, or RAM 125. Illustrative programs include an operating system 135, one or more application programs 136 and an application server 137. In operation, the applications 136 make requests for data to the application server 137. Illustratively, the application server 137 represents a container having an Enterprise JavaBeans (EJB) server 170 and a schema mapper 180. The schema mapper 180 includes an externalize object program 182 (for simplicity, referred to as the “externalizer”) and an internalize object program 184 (for simplicity, referred to as the “internalizer”). In one embodiment, the application server 137 is WebSphere Application Server available from International Business Machines, Inc. In such an embodiment, the application server 137 would also include servlets and a servlet engine to invoke the servlets. A servlet is a relatively small executable code object that can be dynamically plugged in, or added, to the code running on the server. Servlets typically perform some specialized function, which can be invoked by a server (e.g., the EJB server 170) or by another servlet to extend the invoking server's own functionality. The servlet processes the request, and returns the response to the server (or servlet) that invoked it. The relation between the application programs 136 and the application server 137, i.e., the EJB server 170 and the schema mapper 180, is explained in more detail with reference to FIG. 2 below.

A user may enter commands and information into the computer system 102 through input devices such as a keyboard 140 and a pointing device 142. These and other devices may be connected to the processing unit 121 through an interface 145 that is coupled to the system bus. Illustratively, the interface 145 is a serial port interface, but other interfaces, such as a parallel port or a universal serial bus (USB) are also contemplated. A monitor 147 or other type of display device is also connected to the system bus 123 via an interface, such as a video adapter 148. In addition to the monitor 147, the computer system 102 may include other peripheral devices such as speakers and printers.

The computer system 102 may operate in a networked environment using logical connections to one or more remote systems. These logical connections are achieved by a communication device coupled to or part of the computer system 102. The logical connections depicted in FIG. 1 are represented by a network connection 151 and may include a local-area network (LAN) and a wide-area network (WAN). Such networking environments are commonplace in office networks, enterprise-wide computer networks, intranets and the Internet, which are all types of networks. In one embodiment, the network connection 151 is wireless.

The computer system 102 is connected to the network 151 through a network interface or adapter 153, which is one type of communications device. When used in a WAN-networking environment, the computer system 102 may include a modem, or any other type of communications device for establishing communications over the wide area network, such as the Internet. In a networked environment, program modules depicted relative to the computer system 102, or portions thereof, may be stored in the remote memory storage device. It should be appreciated that the network connections shown are exemplary and other means of and communications devices for establishing a communications link between the computers may be used.

Illustratively, the network connection 151 communicates the computer system 102 with a backend resource manager 138 and a remote computer 149 (representing any type of machine, e.g., workstation or personal digital assistant (PDA)). In general, the resource manager 138 may be a relational database, a messaging system, or any type of middleware which provides data management services that can be accessed by an application program 136. In a particular embodiment the backend resource manager 138 is a database server. As such, a database 160 is shown associated with the backend resource manager 138. Although shown separately from the computer system 102, in another embodiment the backend resource manager 138 is a part of the computer system 102. In a particular embodiment, the resource manager 138 is part of a relational database management system (RDBMS). Databases are computerized information storage and retrieval systems. A relational database management system is a computer database management system that uses relational techniques for storing and retrieving data. Relational databases are computerized information storage and retrieval systems in which data in the form of database tables are typically stored for use on disk drives or similar mass data stores. A “table” includes a set of rows (formally denominated “tuples” or “records”) spanning several columns. Where the resource manager 138 is a RDBMS, it is structured to accept commands to store, retrieve and delete data using high-level query languages such as the Structured Query Language (SQL). The term “query” denominates a set of commands for retrieving data from a stored database 160. In particular, an SQL query can declaratively specify the contents of a view. For relational databases, a view is essentially a virtual table having virtual rows and virtual columns of data. Although views are not directly mapped to real data in storage, views can be used for retrieval as if the data they represent is actually stored. A view can be used to present to a user a single logical view of information that is actually spread across one or more tables.

Referring now to FIG. 2, an illustrative relational view 200 of the schema mapper 180 and other components of the invention is shown. More specifically, the relational view 200 illustrates the relationship between the application programs 136, the EJB server 170, the schema mapper 180 including the externalizer 182 and the internalizer 184, and the database 160 of FIG. 1 in one embodiment of the invention.

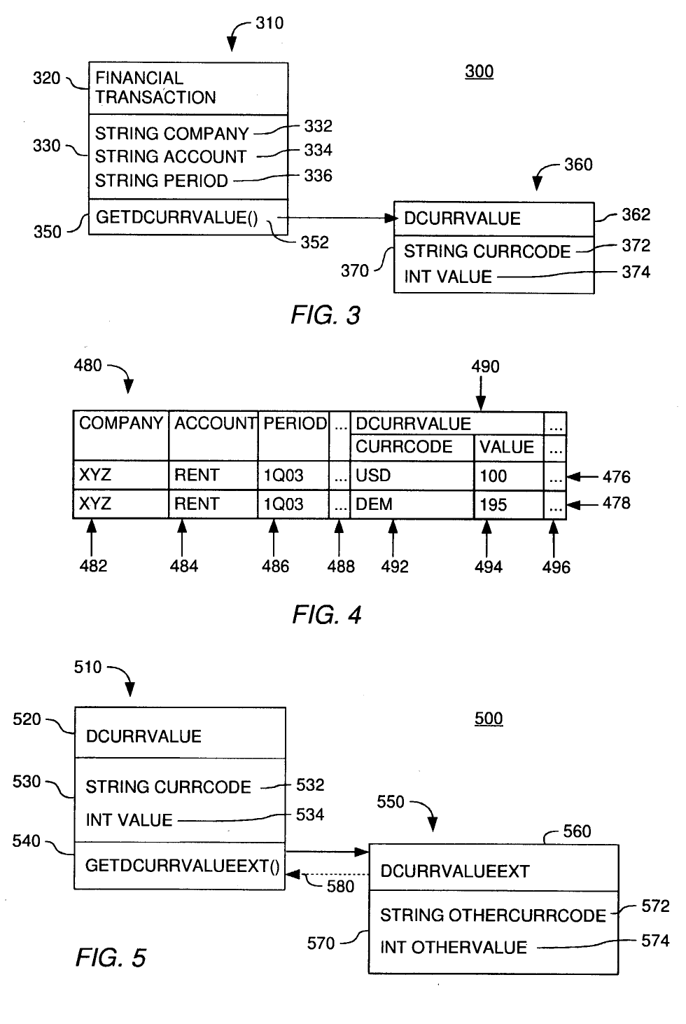

The schema mapper 180 is configured for persisting in the database 160 data from an entity bean 260 containing one or more DVOs 262 using the externalizer 182. Persisting the data in the database 160 may, for instance, be required in order to enable execution of a query 240 issued from an application program 136 against the data in the database 160. In this case, the EJB server 170 receives the query 240 and determines which entity bean 260 contains the data to be queried. The EJB server 170 forwards information describing the determined entity bean 260 and contained DVO(s) 262 to the schema mapper 180. The schema mapper 180 uses the externalizer 182 to access the entity bean 260 (as indicated by arrow 241₁) for determining mapped data attributes and data attributes to be streamed. Examples of mapped data attributes and data attributes to be streamed (and streamed data attributes) are given below with reference to FIGS. 3 to 7. The externalizer 182 persists the data in the database 160 by storing the mapped data attributes as mapped data 246 and the data attributes to be streamed as streamed data 244 in the database 160 (as indicated by arrow 2412). Persisting the data in the database 160 is explained in more detail with reference to FIG. 8 below.

The schema mapper 180 is further configured for hydrating the entity bean 260 with data from the database 160. By way of example, hydrating the entity bean 260 may be required in order to migrate data of an existing underlying database schema (such as a relational schema) designed for use with a specific application to another underlying database schema (such as a XML schema) for use with an alternative application. In this case, the schema mapper 180 uses the internalizer 184 to access the data in the database 160 (as indicated by arrow 242₁). More specifically, the internalizer 184 accesses the mapped data 246 and the streamed data 244 in the database 160. From the mapped data 246, the internalizer 184 determines data attributes which are mapped (for simplicity, also referred to as mapped data attributes). From the streamed data 244, the internalizer 184 determines streamed data attributes. The internalizer 184 hydrates the entity bean 260 by storing the determined mapped data attributes to the entity bean 260 and the determined streamed data attributes to the DVO(s) 262 in the entity bean 260 (as indicated by arrow 242₂). Hydrating the entity bean 260 is explained in more detail with reference to FIG. 9 below.

In the following, an exemplary representation of an entity bean and contained DVO(s) is explained with reference to FIGS. 3 to 7. More specifically, FIGS. 3 to 7 illustrate an exemplary relationship between an entity bean and a DVO and between two different DVOs as well as corresponding data structure representations in the form of database tables.

Referring now to FIG. 3, a data structure 300 is shown that illustrates an exemplary entity bean 310 (referring one instance of an entity bean 260 described above) and a related DVO 360 (referring one instance of a DVO 262 described above). The entity bean 310 includes a field 320 indicating the name of the entity bean 310, i.e., “FINANCIAL TRANSACTION”. This name indicates a table in the database 160 that is associated with the entity bean. The entity bean 310 further includes an attribute field 330 having data attributes 332 “STRING COMPANY”, 334 “STRING ACCOUNT” and 336 “STRING PERIOD”. These data attributes (also referred to as the attributes) may indicate columns in the associated database table in which data from the entity bean 310 is to be stored in a persistent manner. Furthermore, these attributes may indicate columns in the associated database table having data that is stored in the entity bean 310 when the entity bean 310 is hydrated. The entity bean 310 further includes a field 350 having one or more DVOs or, alternatively, one or more access methods for accessing corresponding DVOs. Illustratively, the field 350 contains an access method 352 “GETDCURRVALUE( )” indicating that the related DVO 360 “DCURRVALUE” is contained in the entity bean 310, i.e., that the related DVO 360 is an instance part of the entity bean 310. In other words, when the entity bean 310 is hydrated, all attributes of the DVO 360 are stored in the entity bean 310. Thus, the entity bean 310 comprises a plurality of attributes 332, 334, 336, 372, 374, wherein a portion of the attributes, i.e., the attributes 372 and 374, are associated with the DVO 360 as explained below.

The DVO 360 includes a field 362 indicating the name of the DVO 360, i.e., “DCURRVALUE”. This name may indicate an associated column in a table in the database 160 that the DVO 360 is mapped/streamed to (e.g., column 490 of table 480 of FIG. 4 explained below). The DVO 360 further includes an attribute field 370 having the attributes 372 “STRING CURRCODE” and 374 “INT VALUE”. These attributes may indicate columns in the associated database table in which data from the entity bean 310 which is associated with the DVO 360 is to be stored in a persistent manner. Furthermore, these attributes may indicate columns in the associated database table having data that is stored in the entity bean 310 for the DVO 360 when the entity bean 310 is hydrated.

FIG. 4 shows a database table 480 representing an illustration of data contained in the entity bean 310 of FIG. 3 in the form of a tabular data structure in a relational database environment. The table 480 contains a plurality of rows, each having a plurality of columns. Illustratively, the table 480 contains rows 476 and 478 representing data records, which were schema mapped from the entity bean 310 “FINANCIAL TRANSACTION” and the DVO 360 “DCURRVALUE” contained in the entity bean 310 to the table 480. The rows 476 and 478 include a plurality of columns 482, 484, 486, 488, 490 and 496. By way of example, row 478 indicates that a company “XYZ” has paid from an account “RENT” in a period “1Q03”, i.e., in the first quarter of the year 2003, an amount having a value of “195” in a currency having the currency code “DEM”.

More specifically, columns 482 “COMPANY”, 484 “ACCOUNT” and 486 “PERIOD” correspond to attributes 332, 334 and 336 of the entity bean 310, respectively. In other words, the attributes 332, 334 and 336 are mapped from the entity bean 310 “FINANCIAL TRANSACTION” to columns 482, 484 and 486, respectively, when the entity bean 310 is schema mapped to the database table 480. Column 488 indicates that additional attributes of the entity bean 310 can be mapped to table 480, when specified in field 330 of the entity bean 310. Column 490 “DCURRVALUE” corresponds to the DVO 360 of FIG. 3. In other words, the attributes 372 and 374 are mapped from the DVO 360 “DCURRVALUE” to columns 492 and 494, respectively, when the DVO 360 contained in the entity bean 310 is schema mapped.

Referring now to FIG. 5, a data structure 500 is shown to illustrate a versioned DVO. The data structure 500 includes a DVO 510 and a related DVO 550. More specifically, the DVO 550 is a DVO subclass of the DVO 510. The DVO 510 corresponds to a modified version of the DVO 360 of FIG. 3. Accordingly, like the DVO 360, the DVO 510 includes a name field 520 (corresponding to the field 362 of the DVO 360) indicating the name of the DVO 510, i.e., “DCURRVALUE”. The DVO 510 further includes an attribute field 530 (corresponding to the attribute field 370 of the DVO 360) having attributes 532 “STRING CURRCODE” and 534 “INT VALUE” (corresponding to the attributes 372 and 374, respectively, of the DVO 360).

The DVO 510 has been modified with respect to the DVO 360 of FIG. 3 by introducing an additional field 540 having a related DVO 550. Illustratively, the additional field 540 includes an access method “GETDCURRVALUEEXT( )” indicating that the related DVO 550 “DCURRVALUEEXT” is contained in the DVO 510 and, thus, in the corresponding entity bean 310 of FIG. 3. The DVO 550 includes a field 560 indicating the name of the DVO 550, i.e., “DCURRVALUEEXT”. The DVO 550 further includes an attribute field 570 having attributes 572 “STRING OTHERCURRCODE” and 574 “INT OTHERVALUE”.

For purposes of illustration, the DVO 510 is shown having an access method for accessing the DVO 550. However, as will be appreciated by those skilled in the art, the invention is not limited to such an implementation. Instead, any implementation wherein the DVO 510 represents a parent node and the DVO 550 a child node that depends on the parent node and inherits all attributes there from, as indicated with dashed arrow 580, is contemplated.

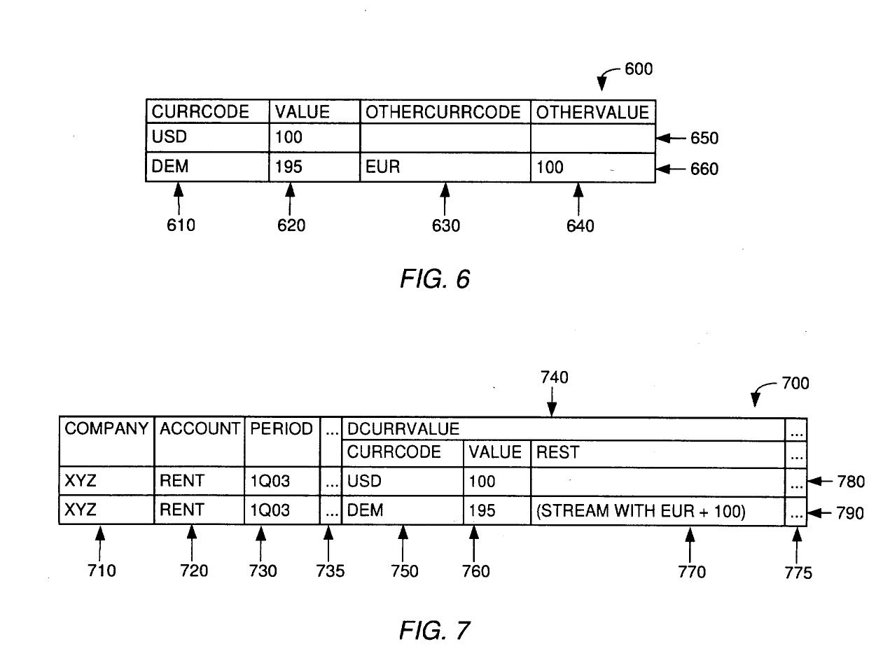

FIG. 6 shows a database table 600 representing an illustration of the DVO 510 (and 550) of FIG. 5 in the form of a tabular data structure in a relational database environment, when the data contained in the DVOs 510 and 550 is schema mapped to the database 160. The database table illustratively includes rows 650 and 660 representing queryable data records. Each of the rows 650 and 660 includes a plurality of columns 610, 620, 630 and 640, to which the data from the DVOs 510 “DCURRVALUE” and 550 “DCURRVALUEEXT” is stored. Illustratively, row 660 indicates that a value of “195” in a currency with a currency code “DEM” corresponds to a value of “100” in a currency with the currency code “EUR”.

More specifically, columns 610 “CURRCODE” and 620 “VALUE” correspond to the attributes 532 and 534 of FIG. 5, i.e., to the attributes 372 and 374 of the DVO 360 of FIG. 3, respectively. Accordingly, the attributes 532 and 534 are mapped from the DVO 510 “DCURRVALUE” to columns 610 and 620, respectively. Columns 630 “OTHERCURRCODE” and 640 “OTHERVALUE” correspond to the attributes 572 and 574 of FIG. 5, respectively, which are mapped from the DVO 560 “DCURRVALUEEXT” to the database table 600.

In other words, in the present example, the modification of the DVO 360 was necessary in order to reflect equivalences of former European currencies, illustratively of “DEM”, with the new currency “EUR”, which has recently been introduced in most European countries. To this end, the new DVO 510 (i.e., a new version of the DVO 360) has been created referencing a corresponding new DVO 560 that inherits the attributes of the DVO 510. The new DVO 510 reflects the equivalences of the former German currency “DEM” to the new European currency “EUR”.

Referring now to FIG. 7, a table 700 is shown that represents an illustration of data contained in the entity bean 310 of FIG. 3 in the form of a tabular data structure in a relational database environment. Specifically, the table 700 reflects the data contained in the entity bean 310 containing the DVO 510 (and thus DVO 550) of FIG. 5 as an instance part. As such, the table 700 is substantially similar to the table 480 shown in FIG. 4, the differences being a result of the distinction between the DVO 360 and the DVO 510.

Illustratively, the table 700 includes rows 780 and 790 having a plurality of columns 710, 720, 730, 735, 740 and 775 containing data from the entity bean 310 “FINANCIAL TRANSACTION” and the DVO 510 “DCURRVALUE” (containing the DVO 550 “DCURRVALUEEXT”). By way of example, row 790 indicates that a company “XYZ” has paid from an account “RENT” in a period “1Q03”, i.e., in the first quarter of the year 2003, an amount having a value of “195” in a currency having the currency code “DEM”, which is equivalent to a value of “100” in the currency with the currency code “EUR”.

More specifically, columns 710 “COMPANY”, 720 “ACCOUNT” and 730 “PERIOD” correspond to attributes 332, 334 and 336 of the entity bean 310, respectively. Accordingly, the attributes 332, 334 and 336 are mapped from the entity bean 310 “FINANCIAL TRANSACTION” to columns 710, 720 and 730, respectively, when data from the entity bean 310 is stored in table 700. Column 735 indicates that additional attributes of the entity bean 310 can be mapped to table 700, when specified in field 330 of the entity bean 310.

Column 740 “DCURRVALUE” corresponds to the DVO 510 of FIG. 5. Accordingly, the attributes 532 and 534 are mapped from the DVO 510 “DCURRVALUE” to columns 750 and 760, respectively, when data associated with the DVO 510 “DCURRVALUE” is stored from the entity bean 310 to the database table 700. The attributes 572 and 574 are streamed from the DVO 550 “DCURRVALUEEXT” to a binary stream in column 770 when data associated with the DVO 550 “DCURRVALUEEXT” is stored from the entity bean 310 to the database table 700. The data in column 770 may, for instance, be streamed for one or more of the following reasons: (i) in order to avoid an unnecessary mapping of data to the database table 700, if use of this data is not unambiguously required for querying applications; (ii) to accelerate updates of entity beans; (iii) to adapt a level of mapping/streaming DVOs dependent on queried data; and/or (iv) to quickly set up a database with replicated data using entity beans. Column 775 indicates that, e.g., additional attributes of the DVO 550 can be streamed to the database table 700, when indicated in the DVO 550.

In the following, persisting data from an entity bean (e.g., entity bean 310 of FIG. 3) in a relational database (e.g., database 160 of FIG. 1) is explained in more detail with reference to FIG. 8. More specifically, FIG. 8 shows a flowchart illustrating a method 800 executed by an externalizer (e.g., externalizer 182 of FIG. 1) for persisting the data from one of the entity bean's DVOs into the database. The entity bean has a plurality of attributes (e.g., attributes 332, 334, 336, 372, 374 of FIG. 3), a portion of which (e.g., attributes 372, 374) is associated with one or more DVOs (e.g., DVO 360 of FIG. 3).

The method 800 begins with step 810 where the externalizer accesses one of the entity bean's independent set of DVO levels in order to locate and determine the plurality of attributes. At step 820, the externalizer retrieves the DVO level(s), i.e., the attributes of the DVO and its parent classes.

At step 830, the externalizer determines whether the attributes of the DVO(s) should be mapped to corresponding columns of a row in a database table in the relational database. To this end, the externalizer determines a dependent value object level (for simplicity, referred to as the DVO level) of the entity bean which defines mapped data attributes. As indicated above, the mapped data attributes represent the attributes of the plurality of attributes which should be mapped to the corresponding columns. Thus, the mapped data attributes represent the DVO level's attributes. In other words, at step 830 the externalizer determines whether the DVO level should be mapped or not.

In one embodiment, the DVO level may be determined by identifying version numbers attributed to the one or more DVOs. In this case, a specific version number of the determined version numbers represents the DVO level. In another embodiment, the DVO level may be the specific level (class) in an inheritance hierarchy being processed.

If the externalizer determines at step 830 that the DVO level should be mapped, the method 800 continues at step 840. At step 840, the mapped data attributes are mapped to the corresponding columns in the row. Mapping the mapped data attributes includes in one embodiment an extraction of data values associated with the mapped data attributes from the entity bean and storing the extracted data values in the corresponding columns.

At step 860, the externalizer determines whether the entity bean includes another DVO level. If it is determined that the entity bean includes at least one other DVO level, a next DVO level is retrieved at step 870 and the method 800 returns to step 830. If it is determined that the entity bean does not contain at least one other DVO level, the method 800 exits at step 880.

If the externalizer determines at step 830 that the DVO level needs not to be mapped, the method 800 continues at step 850. In this case, it is assumed that no mapped data attributes exist for that level and that only data attributes which should be streamed are located at that level, i.e., attributes which should be streamed to a binary stream in a suitable column in the row which is adapted to receive the binary stream. Accordingly, in a preferred embodiment, all remaining attributes of the DVO and all subsequent DVO levels are streamed at step 850 to the suitable column. Alternatively, as indicated with dashed arrow 890, only a current DVO level may be streamed. Thus, after streaming the current DVO level, the method 800 continues at step 860 as described above. This enables for a more selective streaming wherein only selected DVO levels and thus only individual DVOs are streamed. The selection of the DVO levels to be streamed may, for instance, be application-specific or user-selectable. In one embodiment, streaming includes extracting data values associated with the data attributes to be streamed from the DVO. Thus, the binary stream can be generated using the extracted data values. The binary stream is then stored in the suitable column in the row. Method 900 would then be performed for each of the DVOs contained in the entity bean.

In the following, hydrating an entity bean (e.g., entity bean 310 of FIG. 3) with data from a row in a table (e.g., table 700 of FIG. 7) of a relational database (e.g., database 160 of FIG. 1) is explained in more detail with reference to FIG. 9. More specifically, FIG. 9 shows a flowchart illustrating a method 900 executed by an internalizer (e.g., internalizer 184 of FIG. 1) for hydrating one of the entity bean's DVOs with the data from the row. The row has a plurality of columns having mapped data attributes (e.g., columns 710, 720, 730, 750, 760 of FIG. 7) and at least one column having streamed data attributes (e.g., column 770). In one embodiment, the streamed data attributes are associated with one or more DVO levels (e.g., DVOs 510 and 550 of FIG. 5).

The method 900 begins with step 910 where the internalizer accesses the row in the table in order to locate and determine all columns of the row and corresponding attributes for one independent set of DVO levels. At step 920, the internalizer determines the one or more DVO level(s), i.e., the attributes of the one or more DVO level(s), from the corresponding attributes.

At step 930, the internalizer determines whether the attributes of the one or more DVO level(s) are mapped to corresponding columns in the row in order to determine a DVO level of the row which defines mapped data attributes. Mapped data attributes can be extracted from the row and stored to the DVO, i.e., without requiring additional processing.

If the internalizer determines at step 930 that the DVO level is mapped, i.e., that the row includes mapped data attributes, the method 900 continues at step 940. At step 940, the DVO is hydrated with the mapped data attributes. Hydrating the DVO with the mapped data attributes includes in one embodiment an extraction of data values associated with the mapped data attributes from corresponding columns of the row and storing the extracted data values in the DVO.

At step 960, the internalizer determines whether the row includes another DVO level. If it is determined that the row includes at least one other DVO level, a next DVO level is retrieved at step 970 and the method 900 returns to step 930. If it is determined that the entity bean does not contain at least one other DVO level, the method 900 exits at step 980.

If the internalizer determines at step 930 that the DVO level is not mapped, the method 900 continues at step 950. In this case, it is assumed that no mapped data attributes exist and that only streamed data attributes are located. Accordingly, in a preferred embodiment, the internalizer reads the binary stream at step 950 in order to determine the streamed data attributes there from. Then, the internalizer hydrates the DVO with the determined streamed data attributes and exits at step 980. In one embodiment, hydrating the DVO with the streamed data attributes includes extracting data values associated with the streamed data attributes from the binary stream. Thus, the extracted data values are stored in the DVO.

However, if selective streaming is possible, only a current DVO level may be streamed. In this case the method 900 continues after step 950 at step 960 in order to determine whether a next DVO level exists, as indicated with dashed arrow 990. Method 900 is then repeated for each independent set of DVO levels.

While the foregoing is directed to embodiments of the present invention, other and further embodiments of the invention may be devised without departing from the basic scope thereof, and the scope thereof is determined by the claims that follow.

What is claimed is:

1 A method for persisting data from an entity bean in a relational database, the entity bean having a plurality of attributes, at least a portion of the plurality of attributes being associated with one or more dependent value objects, the method comprising:
determining a dependent value object level of the entity bean defining mapped data attributes from a dependent value object of the plurality of attributes;
mapping the mapped data attributes from the dependent value object into a plurality of columns of a row in a table of the relational database; and
streaming all remaining attributes from the dependent value object to a separate column of the table.

2. The method of claim 1 wherein determining the dependent value object level comprises:
providing a version number for each dependent value object of the one or more dependent value objects; and
determining a specific version number as the dependent value object level.

3. The method of claim 1, wherein mapping the mapped data attributes comprises:
extracting data values associated with the mapped data attributes from the dependent value object; and
storing the extracted data values in the plurality of columns.

4. The method of claim 1, wherein streaming all remaining attributes comprises:
generating a binary stream from all the remaining attributes of the dependent value object; and
storing the binary stream in the separate column.

5. The method of claim 4, wherein generating a binary stream comprises:
extracting data values associated with all the remaining attributes from the dependent value object; and
creating the binary stream using the extracted data values.

6. The method of claim 1, further comprising storing the table in memory.

7. A method for hydrating an entity bean with data from a row in a database table of a relational database, the row having a plurality of columns for mapped data attributes and a column for streamed data attributes associated with a dependent value object, the method comprising:
determining a dependent value object level of the row defining the mapped data attributes mapped to the plurality of columns for mapped data attributes;
hydrating the dependent value object with the mapped data attributes from the plurality of columns for mapped data attributes;
extracting the streamed data attributes from the column for streamed data attributes; and
hydrating the dependent value object with the extracted streamed data attributes.

8. The method of claim 7, wherein determining the dependent value object level comprises:
determining, from the row, the plurality of columns for mapped data attributes; and
determining from each column of the determined plurality of columns an associated mapped data attribute.

9. The method of claim 7, wherein hydrating the dependent value object with the mapped data attributes comprises:
extracting data values associated with the mapped data attributes from the row; and
storing the extracted data values in the dependent value object.

10. The method of claim 7, wherein extracting the streamed data attributes comprises:
extracting a binary stream from one of the plurality of columns for streamed data attributes;
extracting data values associated with the streamed data attributes from the extracted binary stream; and
storing the extracted data values in the dependent value object.

11. The method of claim 7, further comprising storing the entity bean in memory.

12. A computer readable medium containing a program which, when executed, performs an operation for persisting data from an entity bean in a relational database, the entity bean having a plurality of attributes, at least a portion of the plurality of attributes being associated with one or more dependent value objects, the operation comprising:
determining a dependent value object level of the entity bean defining mapped data attributes from a dependent value object of the plurality of attributes;
mapping the mapped data attributes from the dependent value object into a plurality of columns of a row in a table of the relational database; and
streaming all remaining attributes from the dependent value object to a separate column of the table.

13. The computer readable medium of claim 12, wherein determining the dependent value object level comprises:
providing a version number for each dependent value object of the one or more dependent value objects; and
determining a specific version number as the dependent value object level.

14. The computer readable medium of claim 12, wherein mapping the mapped data attributes comprises:
extracting data values associated with the mapped data attributes from the dependent value object; and
storing the extracted data values in the plurality of columns.

15. The computer readable medium of claim 12, wherein streaming all remaining attributes comprises:
generating a binary stream from all the remaining attributes of the dependent value object; and
storing the binary stream in the separate column.

16. The computer readable medium of claim 15, wherein generating a binary stream comprises:
extracting data values associated with all the remaining attributes from the dependent value object; and
creating the binary stream using the extracted data values.

17. The computer readable medium of claim 12, further comprising storing the table in memory.

18. A computer readable medium containing a program which, when executed, performs an operation for hydrating an entity bean with data from a row in a database table of a relational database, the row having a plurality of columns for mapped data attributes and a column for streamed data attributes associated with a dependent value object, the operation comprising:
determining a dependent value object level of the row defining the mapped data attributes mapped to the plurality of columns for mapped data attributes;
hydrating the dependent value object with the mapped data attributes from the plurality of columns for mapped data attributes;
extracting the streamed data attributes from the column for streamed data attributes; and
hydrating the dependent value object with the extracted streamed data attributes.

19. The computer readable medium of claim 18, wherein determining the dependent value object level comprises:
determining, from the row, the plurality of columns for mapped data attributes; and
determining from each column of the determined plurality of columns an associated mapped data attribute.

20. The computer readable medium of claim 18, wherein hydrating the dependent value object with the mapped data attributes comprises:
extracting data values associated with the mapped data attributes from the row; and
storing the extracted data values in the dependent value object.

21. The computer readable medium of claim 18, wherein extracting the streamed data attributes comprises:
extracting a binary stream from one of the plurality of columns for streamed data attributes;
extracting data values associated with the streamed data attributes from the extracted binary stream; and
storing the extracted data values in the dependent value object.

22. The computer readable medium of claim 18, further comprising storing the entity bean in memory.
